(19) United States
(12) Patent Application Publication
(10) Pub. No.: US 2014/0279360 A1
(43) Pub. Date: Sep. 18, 2014

(54) FACTOR BASED MATCHING

(71) Applicant: FastMatch, Inc., New York, NY (US)

(72) Inventors: Dmitri Galinov, New York, NY (US); Vladamir Tkach, Fair Lawn, NY (US); Vladislav Rysin, Upper Grandview, NY (US)

(73) Assignee: FastMatch, Inc., New York, NY (US)

(21) Appl. No.: 14/206,101

(22) Filed: Mar. 12, 2014

Related U.S. Application Data
(60) Provisional application No. 61/801,669, filed on Mar. 15, 2013.

(51) Int. Cl. G06Q 40/04

(52) U.S. Cl. CPC G06Q 40/04
USPC 705/37

(57) ABSTRACT

Methods, systems and computer program products to provide execution quality matching are described. A computer-implemented method may include maintaining a fill ratio for each of a set of buyers based on a set of trading-related attributes, maintaining a fill ratio for each of a set of sellers based on a set of trading-related attributes, receiving a quote from a quote provider, receiving one or more orders from one or more different order providers, determining which of the one or more orders to use when filling the quote, and executing a trade between the quote provider and an order provider. Adjusted prices also may be determined for potential trading partners based on one or more trading-related attributes. Further, the adjusted prices may be used when matching buyers and sellers.

### CROSS-REFERENCE TO RELATED APPLICATIONS

This application claims the benefit of U.S. Provisional Application No. 61/801,669, filed Mar. 15, 2013, the entirety of which is incorporated herein by reference.

### TECHNICAL FIELD

The field generally relates to exchange trading and more specifically to performing execution quality matching.

### INTRODUCTION

An electronic trading platform is a computer system used to enable trading of financial products over a network. A trade is generally an exchange of a security, such as stocks, bonds, commodities, currencies, derivatives, or any financial instrument of value, for cash. Electronic trading platforms match orders between liquidity seekers and liquidity providers.

An electronic trading platform may match an order with a quote according to a set of well-defined rules. When a match occurs, the quote provider may have a period of time to either accept or reject proposed terms of the deal. In the financial industry, this is known as a “last look.”

Deals that are rejected by a liquidity provider are failed transactions representing an opportunity cost loss to clients, trading exchanges, and even to liquidity providers who prefer order flow. Thus, reducing rejection rates and enhancing the speed of execution benefits all participants involved. Accordingly, systems and methods are needed to increase fill rates and improve execution speed, which are the main performance characteristics valued in the financial trading industry.

### SUMMARY

Embodiments generally relate to providing execution quality matching. In one embodiment, a computing device maintains a fill ratio for each of a set of buyers based on a set of trading-related attributes, maintains a fill ratio for each of a set of sellers based on a set of trading-related attributes, receives a quote from a quote provider, receives one or more orders from one or more different order providers, determines which of the one or more orders to use when filling the quote, and executes a trade between the quote provider and an order provider.

In another embodiment, a system includes a memory and a processor coupled to the memory to provide fill ratio priority trading. The system maintains a fill ratio for each of a set of buyers based on a set of trading-related attributes, maintains a fill ratio for each of a set of sellers based on a set of trading-related attributes, receives a quote from a quote provider, receives one or more orders from one or more different order providers, determines which of the one or more orders to use when filling the quote, and executes a trade between the quote provider and an order provider.

In a further embodiment, a computer-readable medium has instructions that, when executed by a processor, cause the processor to perform operations. The instructions include computer-readable program code configured to cause the processor to maintain a fill ratio for each of a set of buyers based on a set of trading-related attributes, maintain a fill ratio for each of a set of sellers based on a set of trading-related attributes, receive a quote from a quote provider, receive one or more orders from one or more different order providers, determine which of the one or more orders to use when filling the quote, and execute a trade between the quote provider and an order provider.

Further embodiments, features, and advantages of the disclosure, as well as the structure and operation of the various embodiments of the disclosure are described in detail below with reference to accompanying drawings.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. The drawing in which an element first appears is generally indicated by the left-most digit in the corresponding reference number.

FIG. 1 illustrates a block diagram of a system providing execution quality matching, in accordance with various embodiments of the present disclosure.

FIG. 2 is a flow diagram illustrating execution quality matching, according to an embodiment.

FIG. 3 is a block diagram of an exemplary computer system that may perform one or more of the operations described herein.

### DETAILED DESCRIPTION

This disclosure is generally directed to providing execution quality matching. Embodiments described within the present disclosure provide increased fill rates and execution speed to improve trading between buyers and sellers.

FIG. 1 illustrates a block diagram of a system providing execution quality matching, in accordance with various embodiments of the present disclosure. System 100 includes quote providers 110A-110C, trading platform 120, order providers 130A-130C, and execution quality matching system 140.

System 100 includes one or more computer systems connected to a network. The network may be, for example, a public network (e.g., the Internet), a private network (e.g., a local area network (LAN) or wide area network (WAN)), or a combination thereof. For example, quote providers 110A-110C, trading platform 120, order providers 130A-130C, and execution quality matching system 140 each may be comprised of one or more computing systems that are connected over one or more different computer networks.

The computer systems may include personal computers (PC), laptops, mobile phones, tablet computers, or any other computing device. The computer systems may run an operating system (OS) that manages hardware and software. The computer systems also may include one or more server machines. A server machine may be a rackmount server, a router computer, a personal computer, a portable digital assistant, a mobile phone, a laptop computer, a tablet computer, a camera, a video camera, a netbook, a desktop computer, a media center, any other type of computing device, or any combination thereof.

The system 100 also may include one or more persistent data stores, such as a file server or network storage, capable of storing various types of data. In some embodiments, the data store might include one or more other types of persistent storage such as an object-oriented database, a relational database, and so forth.

Quote providers 110A-110C and order providers 130A-130C may be buyers seeking to obtain liquidity from the market or sellers offering liquidity to the market. In one example, when a quote provider is a buyer, then the quote provider is matched with one or more order providers who are selling. In another example, when the quote provider is a seller, then the quote provider is matched with one or more order providers who are buying. In a further example, buyers orders are directly matched with sellers orders.

Trading platform 120 may be an electronic trading platform. Electronic trading platforms are computer system that may be used to place and fill orders for financial products over a network. Trading platform 120 may be managed and operated by a financial intermediary. Financial products such as shares, bonds, currencies, commodities, derivatives, etc. may be bought and sold using a trading platform 120. Financial products also may include foreign exchange spots and metals transactions. According to an embodiment, trading platform 120 may be a real-time or near real-time electronic trading platform.

According to an embodiment, trading platform 120 may facilitate trades between quote providers 110A-110C and order providers 130A-130C. For example, trading platform 120 may match orders between buyers and sellers. Buyers and sellers each may each submit a quote/offer, and if the price between the quote and the offer matches, then a trade may be executed between the buyer and the seller. A trading platform may match buyers and sellers based on one or more of order price, order timing, and/or order size.

In one example, an order from a buyer may be matched to an order from a seller. In another example, a quote may be first provided by a buyer or a seller. The quote may then be matched to one or more corresponding orders. The quote provider then may be informed that one or more matching orders exist for the quote. The quote provider then may confirm or reject the trade.

Price fill ratio or “fill ratio” generally refers to how many times a particular trader confirms a quote versus how many times a particular trader denies a quote. For example, the trader may submit 100 quotes and actively trade on 60 of the submitted quotes. Thus, the trader's fill ratio for the set of quotes is 60%.

In one example, a trader's fill ratio may be determined for all quotes that the trader has submitted. In another example, a trader's fill ratio may be computed based on one or more trading attributes such as quotes provided to a particular buyer and/or seller. Thus, a trader may have different fill ratios for each buying/selling customer on the other side.

Trading platform 120 includes execution quality matching system 140. Execution quality matching system includes fill ratio maintainer 142, quote receiver 144, order receiver 146, match determiner 148, and trade execution engine 150.

Price fill ratio maintainer 142 computes, tracks, and maintains fill ratio statistics for each buyer and seller. Quote receiver 144 receives quotes from buyers and/or sellers. Order receiver 146 receives orders from buyers and/or sellers. Match determiner 148 matches quotes from a quote providers orders from order providers. Trade execution engine 150 executes trades for between matching buyers and sellers.

In one example, a seller wants to sell a financial instrument at $20. There are three available buyers at $20. Execution quality matching system 140 may analyze historical performance between the seller and each of the buyers. In one example, a first buyer may have a 90% fill rate with the seller, a second buyer may have a 70% full rate with the seller, and a third buyer may have a 50% fill rate with the seller.

In an example, execution quality matching system 140 matches the seller with the first buyer (having the 90% fill rate) because the first buyer has the highest historical fill rate with the seller, as compared to other available buyers at the same price. The trade execution engine 150 may then execute the trade between the matched buyer and seller.

According to various embodiments, buyers and sellers are not matched based on given price of quotes or orders offered by buyers and sellers, as shown in one example above. Instead, buyers and sellers may be matched based on an adjusted price determined for each of one or more liquidity providers. An adjusted price may be calculated for each liquidity provider based on a set of criteria. For example, an adjusted price may be calculated based on one or more trading-related attributes, such as fill ratio, time of day, pair, and response time.

In one example, buyers and sellers are matched based on adjusted prices, not based on given prices. In another example, an area of a trading system may match buyers and sellers based on adjusted prices and a different area of a trading system may match buyers and sellers based on given prices. A buyer or seller may also indicate whether it would like to view adjusted and/or given prices.

FIG. 2 is a flow diagram illustrating execution quality matching, according to an embodiment. The method 200 may be performed by processing logic that may comprise hardware (circuitry, dedicated logic, programmable logic, microcode, etc.), software (such as instructions run on a general purpose computer system, dedicated machine, or processing device), firmware, or a combination thereof. In one example, the method 200 is performed by execution quality matching system 140 of FIG. 1.

At stage 210, a fill ratio is maintained for each of a set of buyers based on a set of trading-related attributes. In addition, at stage 220, a fill ratio is maintained for each of a set of sellers based on a set of trading-related attributes.

In an embodiment, one or more calculated fill ratios are maintained for each buyer on a trading platform. For example, one or more fill ratios may be calculated for a buyer based on one or more trading related attributes. Trading related attributes may include, but are not limited to, an instrument that is being traded, a currency (symbol), size of a transaction, one or more other parties involved in a potential transaction (e.g., buyer(s) and/or seller(s)), a time of day, response time of a liquidity provider, etc.

In one embodiment, a fill ratio is calculated as an overall fill ratio that includes every available transaction for a period of time. In an example, one or more fill ratios may be calculated and maintained based on one or more different trading-related attributes and/or combinations of trading-related attributes. Thus, a fill ratio value may be calculated based on a single attribute such as currency or based on multiple attributes such as currency, potential transaction size, and potential trading partner.

In one embodiment, one or more fill ratios may be weighted and combined. Also, one or more fill ratios may be updated dynamically, meaning that the price all ratios are updated at or near the end of completion or cancellation of any associated transaction. One or more fill ratios also may be updated periodically, for example, as a nightly or batch job.

According to an embodiment, a fill ratio for a currency pair may be defined as the ratio of successful deal notational amounts in a base currency unit (e.g., an amount of Euros in a Euro/US Dollar deal) to total matched deal notational amounts in the same units. In another embodiment, a fill rate may be defined as a ratio of accepted fills to a total number of potential/possible fills. In one example, execution time may be defined as the 99^{th} percentile of accepted match response time. Stages 210 and 220 may be performed by, for example, fill ratio maintainer 142.

At stage 230, a quote is received from a quote provider. According to an embodiment, a quote may be received from a buyer or a seller. Quotes received from buyers may be matched with quotes received from sellers and vice versa. According to an embodiment, a quote provider and/or trading platform may select fill ratio criteria based on one or more trading related attributes to be utilized when evaluating orders. Stage 230 may be performed by, for example, by quote receiver 144.

At stage 240, one or more orders are received from one or more different order providers. According to an embodiment, a fill ratio based on one or more trading-related attributes is calculated or retrieved (e.g., pre-calculated). Trading-related attributes used to calculate/obtain a fill ratio associated with the party providing the order may be defined by one or more of a quote provider and a trading platform (e.g., a public or private electronic exchange). Each of the trading related attributes may be assigned equal or various weightings which may be used to calculate an associated fill ratio.

For example, a quote provider or a trading platform may choose to evaluate orders based on an instrument to be traded, the proposed transaction size, and time of day. Each one of the trading-related attributes may be assigned equal weight (e.g., ⅓ in this non-limiting example) or another weighting (e.g., 45%, 30, 25%). Thus, each fill rate calculated for a single or combined set of trading related attributes may be weighted and combined to produce a trading match partner score. Each match then may be ranked based on its calculated trading match partner score.

In one example, one or more attempts are made to trade on a list of matching orders ranked according to trading match partner score. In another example, when two or more liquidity providers have the same fill ratio, then one or more trading based attributes may be used as tiebreakers. For example, when two liquidity providers have the same fill ratio one provider may be chosen over another based on response time (e.g., average historical response time).

In an example, a trading match partner score may be based on trading-related attributes for transactions associated with one or more order providers. For example, the trading match partner score may be based on a set of historical transactions or interactions that have occurred between two parties. However, a trading match partner score also may be determined based on an overall fill ratio that uses transactions from any client. Other groupings, such as by industry, sector, etc. may be used as well when not enough significant transaction history (or no history) exists between a quote provider in order provider. For example, when a buyer and seller have never interacted, then system may default to using a historical fill ratio across all clients a particular party has interacted with (for example, in one or more different roles—as a buyer, as a seller, or as both a buyer and a seller).

In some examples, one or more matches may be disregarded when a party on either side of a potential trade (1) does not meet and/or (2) exceeds one or more thresholds. For example, any order provider, including the highest ranked order provider may be disregarded when one of its particular fill ratios falls below 50% after 5 PM (or some other set of criteria).

In one embodiment, fill ratios are calculated based on data within a particular period of time (e.g., day, week, month, quarter, year, etc.). In another embodiment fill ratios are calculated using all available data. On Stage 240 may be performed by, for example, by order receiver 146.

According to an embodiment, buyers and sellers each may choose to be matched with other parties based on adjusted prices determined for the other parties. For example, a buyer or seller may configure one or more price adjustments to be made for parties on the other side of a potential match. A price adjustment may be configured by assigning a weight, numerical value, formula, etc. to each of one or more trading-related attributes, such as fill ratio, time of day, pair, response time, etc. The configured trading-related attributes may be used to calculate an adjusted provider price quote based on a given (e.g., stated, original) price quote. For example, a given price may be adjusted upwards or downwards based on preferences associated with trading-related attributes.

In one example, a buyer or a seller may set one or more thresholds corresponding to trading-related attributes. A potential trading partner may then be evaluated based on the trading-related attributes. For example, for a particular buyer or seller, each of one or more potential trading partners may be evaluated based on an adjusted price. The adjusted price may be calculated for each potential trading partner by evaluating the potential trading partner's performance in comparison to one or more defined trading-related attribute thresholds.

When a potential trading partner's performance meets, exceeds, or falls short of a defined trading-related attribute threshold, the potential partner's price may be adjusted upwards/downwards accordingly. An adjusted price calculated for a potential trading partner may be based on one or more adjustments associated with one or more trading-related attributes. Further, a buyer or seller then may be matched based to potential trading partners based on adjusted prices calculated for each of the potential trading partners.

A buyer or seller may configure price adjustment calculations so that potential trading partners providing high levels of service in areas that are important to the buyer/seller appear more favorable (even if providing a given price that is not the most competitive). Similarly, potential trading partners who have historically provided lower levels of service in areas important to a buyer/seller may be penalized by price adjustments accordingly.

At stage 250, a determination is made as to which of the one or more orders is to be used when filling the quote. In one example, each matching liquidity provider and each instrument are analyzed. Statistical analysis is performed to establish each liquidity provider's relative ranking based on fill rate and execution time. Variability of both fill rate and execution time may be analyzed for each liquidity provider based one or more of the following contributing factors: foreign-exchange (FX) currency pair, time of day, and match quantity.

Fill rate and execution time may be combined into a single liquidity provider rank number weighed by relative importance. Relative importance weights of fill rate and execution time may be determined using statistical analysis of data provided by survey data and market experts.

In addition to establishing historical liquidity provider rank, real time sampling of both fill rate and execution time may be combined to calculate a current liquidity provider rank that may be used in the matching algorithm (using both current and historical ranks). Additionally, minimal thresholds for fill rate and/or execution time may be established. Such criteria may be automatically established (e.g., as a system default) until manually or automatically reset.

In another embodiment, liquidity provider rank may be translated into a rate offset to be used in a matching algorithm. Current matching engine logic may be modified to consider a liquidity provider's quoted rate adjusted for rate offset at the point in the algorithm where the foreign exchange rates of each quote are considered.

In an example, bid rate may be decreased and offer rate may be increased by the amount in fractions of PIP inversely proportional to liquidity provider ranking. Once an eligible quote selected for a match, a trade may be executed using existing matching rules honoring both the taker rate and a liquidity provider rate proposed for execution on a platform.

For example, a first liquidity provider submits an offer of 1.30793 and a second liquidity provider provides an offer of 1.30783 EUR/USD. In this example, a rank of the first liquidity provider is 96% and a rank of the second liquidity provider is 71%. Further, a single point of rank is worth 0.00001.

Effective rate of the first liquidity provider equals 1.30793+(100−96) times 0.00001 equals 1.30797. Effective rate of the second liquidity provider equals 1.30783+(100−71) times 0.00001. Thus, the effective rate of the first liquidity provider is better in ranking and if the taker rate and liquidity provider actual rate of 1.30793 match according to unadjusted exchange rules (for example, the taker order has a limit rate of 1.30793), the match may be performed based on the first liquidity provider quote.

In one example, buyers and sellers are not matched based on a given/state price. Instead, a buyer may configure a price adjustment to be applied to one or more liquidity providers that are potential trading partners. The buyer may assign a weight, formula, or quantitative factor to one or more trading-related attributes that are then used to calculate an adjusted price for each of the potential trading partners. The buyer may be matched with sellers/liquidity providers based on an adjusted price reflecting buyer preferences based on trading-related attributes.

In an example, a first buyer has two potential trading partners A and B. Trading partner A has a more aggressive price, but has a poor fill ratio. Trading partner B has a less aggressive price, but a great fill ratio. Traditional systems that match on a given or stated price may automatically match the first buyer with trading partner A based on the aggressive price offered by A. However, when the first buyer configures an adjusted price for trading partners to give increased weight to trading partners with high fill rates, then trading partner B may actually have an adjusted price that is higher than trading partner A's adjusted price.

Thus, in the eyes of the buyer, potential trading partner A is penalized and potential trading partner B is awarded for their performance in an area that is considered important to the first buyer. Further, price adjustments originating from one or more trading-related attributes may be used to produce a final/combined adjusted price for a potential trading partner.

A second buyer may configure a threshold so that any potential trading partner with a poor fill rate is automatically excluded from consideration as a potential trading partner. Thus, potential trading partner A would be excluded, even if A offered the best given/stated price.

Accordingly, adjusted prices allow each buyer to see a different view of the market based on what trading-related factors are important and unimportant to them. Stage 250 may be performed by, for example, by match determiner 148.

At stage 260, the trade is executed between the quote provider and in order provider based on the fill ratio of the order provider. According to an embodiment, the matching list of ranked providers meeting a set of criteria, if any, is produced. Execution quality matching system 140 may proceed by attempting to trade on the highest ranked matching partner. When the highest ranked matching partner is not available, then the next highest ranked matching partner is considered, and so forth. In another example, a trade may be executed based on an adjusted price of a liquidity provider.

In an example, when a match is found, the matching order is sent to the quote provider who may then accept or reject the match. When the quote provider accepts the matching order then the trade may be executed. When the quote provider rejects the matching order, then the provided quote may be terminated or the quote provider may be given the opportunity to trade with the next highest ranked matching order until no other matching orders exist. Stage 260 may be performed by, for example, trade execution engine 150.

FIG. 3 illustrates a diagram of a machine in the exemplary form of a computer system 300 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processing device (processor) 302, a main memory 304 (e.g., read-only memory (ROM), flash memory, dynamic random access memory (DRAM) such as synchronous DRAM (SDRAM), double data rate (DDR SDRAM), or DRAM (RDRAM), etc.), a static memory 306 (e.g., flash memory, static random access memory (SRAM), etc.), and a data storage device 318, which communicate with each other via a bus 330.

Processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 302 may also be one or more special-purpose processing devices such as an application specific integrated circuit (ASIC), a field programmable gate array (FPGA), a digital signal processor (DSP), network processor, or the like. The processor 302 is configured to execute instructions 322 for performing the operations and steps discussed herein.

The computer system 300 may further include a network interface device 308. The computer system 300 also may include a video display unit 310 (e.g., a liquid crystal display (LCD) or a cathode ray tube (CRT)), an alphanumeric input device 312 (e.g., a keyboard), a cursor control device 314 (e.g., a mouse), and a signal generation device 316 (e.g., a speaker).

The data storage device 318 may include a computer-readable storage medium 328 on which is stored one or more sets of instructions 322 (e.g., software) embodying any one or more of the methodologies or functions described herein. The instructions 322 may also reside, completely or at least partially, within the main memory 304 and/or within the processor 302 during execution thereof by the computer system 300, the main memory 304 and the processor 302 also constituting computer-readable storage media. The instructions 322 may further be transmitted or received over a network 320 via the network interface device 308.

In one embodiment, the instructions 322 include instructions for implementing an execution quality matching system (e.g., execution quality matching system 140 of FIG. 1) and/or a software library containing methods to implement one or more services of an execution quality matching system. While the computer-readable storage medium 328 (machine-readable storage medium) is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the disclosure should therefore be determined with reference to the appended claims, along with the full scope of equivalents to which such claims are entitled.

The following is an excerpt from U.S. Provisional Patent Application No. 61/801,669, filed Mar. 15, 2013, of which the present application claims the priority and which is incorporated by reference herein above:

A computer-implemented method, comprising: maintaining, by a computing device, a fill ratio for each of a set of buyers based on a set of trading-related attributes; maintaining, by the computing device, a fill ratio for each of a set of sellers based on a set of trading-related attributes; receiving, by the computing device, a quote from a quote provider; receiving, by the computing device, one or more orders from one or more different order providers; determining, by the computing device, which of the one or more orders to use when filling the quote; and executing, by the computing device, a trade between the quote provider and an order provider.

A system, comprising: a memory; and a processor coupled with the memory to: maintain a fill ratio for each of a set of buyers based on a set of trading-related attributes; maintain a fill ratio for each of a set of sellers based on a set of trading-related attributes; receive a quote from a quote provider; receive one or more orders from one or more different order providers; determine which of the one or more orders to use when filling the quote; and executing a trade between the quote provider and an order provider.

A computer readable medium having instructions recorded thereon that, when executed by a processor, cause the processor to perform operations comprising: maintaining, by a computing device, a fill ratio for each of a set of buyers based on a set of trading-related attributes; maintaining, by the computing device, a fill ratio for each of a set of sellers based on a set of trading-related attributes; receiving, by the computing device, a quote from a quote provider; receiving, by the computing device, one or more orders from one or more different order providers; determining, by the computing device, which of the one or more orders to use when filling the quote; and executing, by the computing device, a trade between the quote provider and an order provider.

The following is an excerpt from U.S. Provisional Patent Application No. 61/801,669, filed Mar. 15, 2013, of which the present application claims the priority and which is incorporated by reference herein above:

FastMatch platform accepts orders from clients (typically participants who take liquidity from the platform) and quotes from liquidity providers (LP) who are there to add or provide liquidity to the market place. Current instruments on FastMatch platform are spot FX and metals transactions (for example, EUR/USD).

FastMatch platform may match either order with another order from two clients or order with LP quote according to well defined rules accepted by all participants. When match occurs between order and LP quote, LP in FastMatch have up to N milliseconds to either accept proposed terms of deal on FastMatch or reject it. This is a known as ‘last look’ in the industry. Deals rejected by LP are failed mini-auctions and represent loss as opportunity cost to clients and FastMatch and even LPs since many LPs would rather see order flow that they would not reject. Reducing LP reject rate and enhancing execution speed is in the interests of all participants.

This document proposes a number of new methods and techniques for ranking LP on FastMatch platform designed to increase fill rates and execution speeds which are main performance characteristics accepted in the industry.

FillRate per currency pair may be defined as percentage ratio of successful deal notional amount in base currency units (for example amount of EUR in EUR/USD deal) to total matched deal notional amount in the same units. Alternatively FillRate may be defined as ratio of accepted fills to total number of potential fills. ExecutionTime will be defined as 99th percentile of accepted match response time.

LP Historical Performance Analysis

FastMatch will analyze the data potential matches for each LP and for each instrument and perform statistical analysis that will establish each LP's relative ranking on FillRate and ExecutionTime. Variability of both FillRate and ExecutionTime will be analyzed for each LP according to the following contributing factors: FX currency pair, time of day, and match quantity.

FillRate and ExecutionTime will be combined into a single LPRank number weighed by relative importance. Relative importance weights of FillRate and ExecutionTime will be determined using statistical analysis of found data and survey of market experts.

LP Performance Measurement

In addition to establishing historical LPRank, FastMatch will sample in real time both FillRate and ExecutionTime and combine to calculate current LP rank that will be used in the matching algorithm using both current and historical ranks. Additionally cutoff criteria will be established for very poor performance such that total cutoff based on very low FillRate or ExecutionTime will be automatically established until manual or automated reset. Combined LPRank will be computed and disseminate to matching engines.

Order with Quote Matching using LP ranking.

LPRank will be translated into RateOffset to be used in the matching algorithm. Current matching engine logic will be modified to consider LP quote's rate adjusted for RateOffset at the point in the algorithm where FX rates of each quote are considered.

Bid rate will be decreased and offer rate increased by the amount in fractions of pip inversely proportional to LP ranking. Once eligible quote is selected for match, deal will be executed using existing FastMatch matching rules, honoring both taker rate and LP rate proposed for execution on the platform.

For example, LP1 submits an offer of 1.30793 and LP2 has an offer of 1.30783 for EUR/USD. Suppose LP1 rank is 96% and LP2 rank is 71% and 1 point of rank is worth 0.00001.

Effective LP1 rate=1.30793+(100−96)*0.00001=1.30797; LP2rate=(100−71)*0.00001+1.30783=1.30812.

LP1 rate is much better in ranking and so if taker rate and LP1 actual rate 1.30793 match according to unadjusted exchange rules (for example, taker order has a limit rate of 1.30793), match will be done with 1.30793 LP1 quote.

1. A method, comprising:
receiving, by a computing device, a quote from a quote provider;
receiving a plurality of orders from a plurality of order providers;
determining rank values of the order providers associated with orders that have prices matching the quote;
identifying an order provider having an optimal rank value; and
matching the quote with an order presented by the order provider having the optimal rank value.

2. The method of claim 1, wherein a rank value of an order provider is represented by an order fill rate by the quote provider with respect to the order provider.

3. The method of claim 1, wherein the rank value of an order provider is represented by a weighted sum of the order fill rate and an order execution time by the quote provider with respect to the order provider.

4. The method of claim 2, wherein the order fill rate by the quote provider with respect to the order provider is a ratio of a number of confirmed trades between the order provider and the quote provider to a number of orders presented by the order provider to the quote provider.

5. The method of claim 2, wherein the order fill rate is determined with respect to trades having pre-determined values of one or more trading attributes selected from the group comprising: an instrument being traded, a currency of the trade, a transaction size, a time of day, a period of time, and a response time of the order provider.

6. The method of claim 5, further comprising:
receiving the trading attributes from at least one of: the quote provider or a trading platform.

7. The method of claim 1, further comprising:
updating, responsive to the matching, the rank value of the order provider having the optimal rank value.

8. The method of claim 1, further comprising:
using a trading attribute as a tie-breaker to select an order provider among two order providers having equal rank values, wherein the trading attribute is selected from the group comprising: an instrument being traded, a currency of the trade, a transaction size, a time of day, a period of time, and a response time of the order provider.

9. The method of claim 1, further comprising:
disqualifying an order provider having a value of a trading attribute exceeding a threshold value, wherein the trading attribute is selected from the group comprising: an instrument being traded, a currency of the trade, a transaction size, a time of day, a period of time, and a response time of the order provider.

10. The method of claim 1, further comprising:
determining, based on the rank values, adjusted price values for the plurality of orders.

11. A method, comprising:
receiving, by a computing device, a quote from a quote provider;
receiving a plurality of orders from a plurality of order providers;
determining rank values of the order providers with respect to the quote provider;
determining, based on the rank values, adjusted price values for the plurality of orders; and
matching, based on the adjusted price values, the quote with an order presented by the identified order provider.

12. The method of claim 10, wherein the rank value of an order provider is represented by an order fill rate by the quote provider with respect to the order provider.

13. The method of claim 10, wherein the rank value of an order provider is represented by a weighted sum of an order fill rate by the quote provider with respect to the order provider and an order execution time by the quote provider with respect to the order provider.

14. The method of claim 12, wherein the order fill rate by the quote provider with respect to the order provider is a ratio of a number of confirmed trades between the order provider and the quote provider to a number of orders presented by the order provider to the quote provider.

15. The method of claim 12, wherein the order fill rate is determined with respect to trades having pre-determined values of one or more trading attributes selected from the group comprising: an instrument being traded, a currency of the trade, a transaction size, a time of day, a period of time, and a response time of the order provider.

16. The method of claim 15, further comprising:
receiving the trading attributes from at least one of: the quote provider or a trading platform.

17. The method of claim 10, wherein the adjusted price is determined based on values of one or more trading attributes selected from the group comprising: a an order fill rate, an instrument being traded, a currency of the trade, a transaction size, a time of day, a period of time, and a response time of the order provider.

18. The method of claim 10, wherein the adjusted price is represented by an offer price modified by an amount which is inversely proportional to a rank value of the quote provider.

19. A computer-readable non-transitory storage medium comprising executable instructions that, when executed by a computer system, cause the computer system to perform operations, comprising:
receiving, by a computing device, a quote from a quote provider;
receiving a plurality of orders from a plurality of order providers;
determining rank values of the order providers associated with orders that have prices matching the quote;
identifying an order provider having an optimal rank value; and
matching the quote with an order presented by the order provider having the optimal rank value.

20. The computer-readable non-transitory storage medium of claim 19, wherein the rank value of an order provider is represented by a weighted sum of the order fill rate and an order execution time by the quote provider with respect to the order provider.
